(19) United States
(12) Patent Application Publication
(10) Pub. No.: US 2026/0249716 A1
(43) Pub. Date: Aug. 27, 2026

(54) CHARGING INLET

(71) Applicant: YAZAKI CORPORATION, Tokyo (JP)

(72) Inventors: Noriyoshi Yamanishi, Kakegawa-shi (JP); Shoya Ueda, Kakegawa-shi (JP)

(21) Appl. No.: 19/340,890

(22) Filed: Sep. 26, 2025

(30) Foreign Application Priority Data
Sep. 30, 2024 (JP) 2024-170564

(51) Int. Cl. B60L 53/16; H01R 13/52

(52) U.S. Cl. CPC B60L 53/16; H01R 13/5213; H01R 13/5219

(57) ABSTRACT

The charging inlet includes a housing, a wiring component, a waterproof plug that closes a routing passage, and a cap member that is attached to an external opening portion of a wiring guide formed on a side of an outer surface of an outer wall portion of the housing, the external opening portion being opened to an outside of the housing, the cap member having a plug abutting portion capable of abutting on the waterproof plug inside the wiring guide from a side of the external opening portion. The cap member includes a U-shaped cut-out opened to the side of the outer wall portion in a second direction intersecting the outer surface of the outer wall portion when viewed from a first direction along the outer surface of the outer wall portion of the housing, and the wiring component is inserted into the cut-out.

### TECHNICAL FIELD

Embodiments of the present invention relate to a charging inlet.

Priority is claimed on Japanese Patent Application No. 2024-170564 filed in Japan on Sep. 30, 2024, the content of which is incorporated herein by reference.

### BACKGROUND ART

Conventionally, a connector installed in a vehicle has been proposed in order to supply (charge) an electric power from an outside of the vehicle to a battery mounted on the vehicle such as an electric vehicle or a plug-in hybrid vehicle (see, for example, Patent Document 1). This type of connector is also commonly referred to as a charging inlet.

### PRIOR ART DOCUMENT

### Patent Document

[Patent Document 1] Japanese Unexamined Patent Application, First Publication No. 2019-186022

### SUMMARY OF THE INVENTION

### Problems to be Solved by the Invention

In the charging inlet, it is expected to facilitate assembly while securing waterproofness.

One embodiment provides a charging inlet having improved assemblability while securing waterproofness.

### Means for Solving the Problem

A charging inlet of one embodiment includes: a housing from which a charging plug is detachable, the housing holding connection terminals therein; a wiring component inserted into the housing from an outside of the housing through a wiring guide formed on a side of an outer surface of an outer wall portion of the housing; a waterproof plug inserted into a routing passage inside the wiring guide together with the wiring component to close the routing passage; and a cap member that is attached to an external opening portion of the wiring guide, the external opening portion being opened to the outside of the housing, and that has a plug abutting portion capable of abutting on the waterproof plug inside the wiring guide from a side of the external opening portion, wherein the cap member includes a U-shaped cut-out opened to a side of the outer wall portion in a second direction intersecting the outer surface of the outer wall portion when viewed from a first direction along the outer surface of the outer wall portion, and the wiring component is inserted into the cut-out.

### Effects of Invention

According to the one embodiment, a charging inlet having improved assemblability while securing waterproofness can be provided.

### BRIEF DESCRIPTION OF THE DRAWINGS

FIG. 1 A perspective view of a charging inlet according to one embodiment of the present invention.

FIG. 2 A perspective view of the charging inlet when viewed from a different direction.

FIG. 3 A cross-sectional view along an axial direction of a central portion in a left-right direction of the charging inlet.

FIG. 4 A cross-sectional view taken along line A-A of FIG. 3.

FIG. 5 A cross-sectional view taken along line B-B of FIG. 3.

FIG. 6 A perspective view of a state in which a cap member is removed from an upper wiring guide of the charging inlet.

### EMBODIMENTS FOR CARRYING OUT THE INVENTION

Specific embodiments of the present invention will be described below with reference to the drawings. In the following description, constitutions having the same or similar functions are denoted by the same reference signs. Redundant descriptions of these constitutions may be omitted. Note that constitutions described below do not limit the scope of the embodiments.

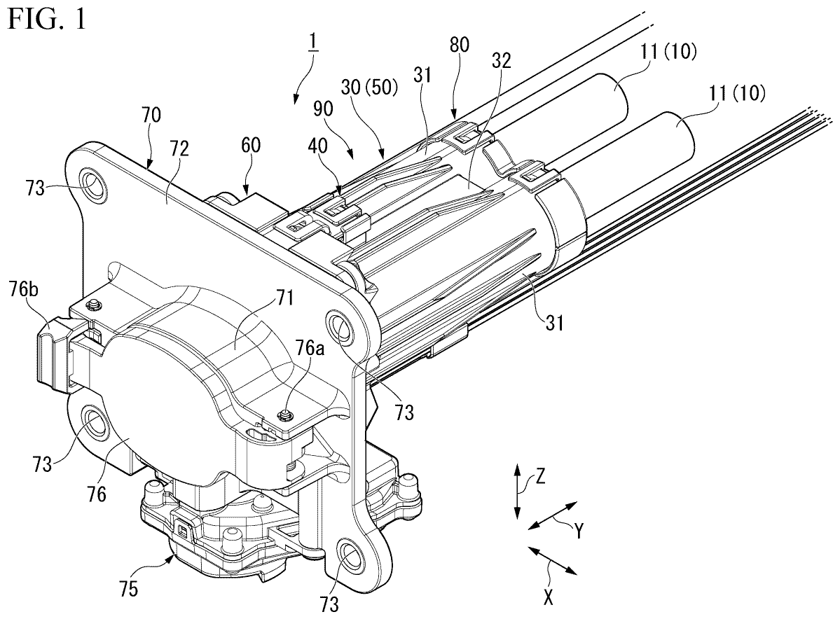

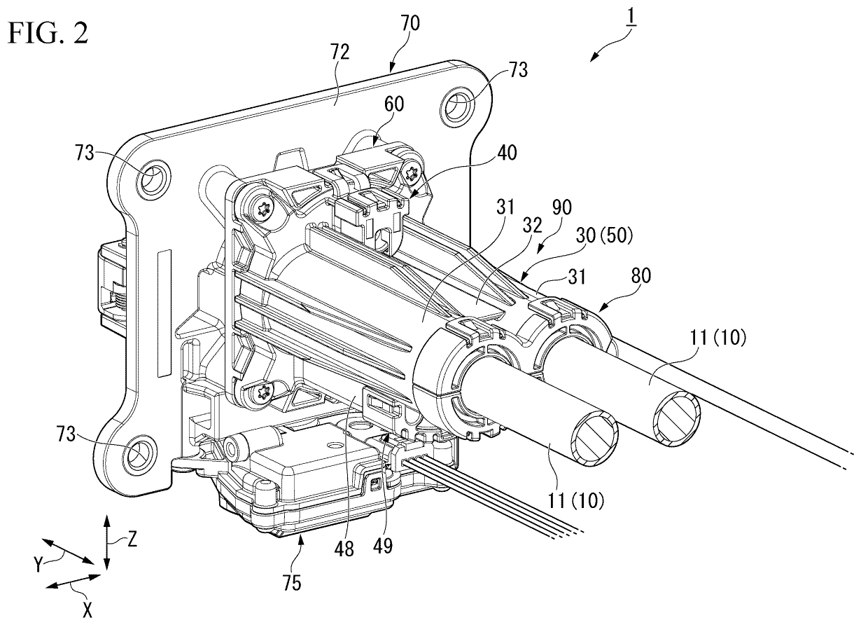

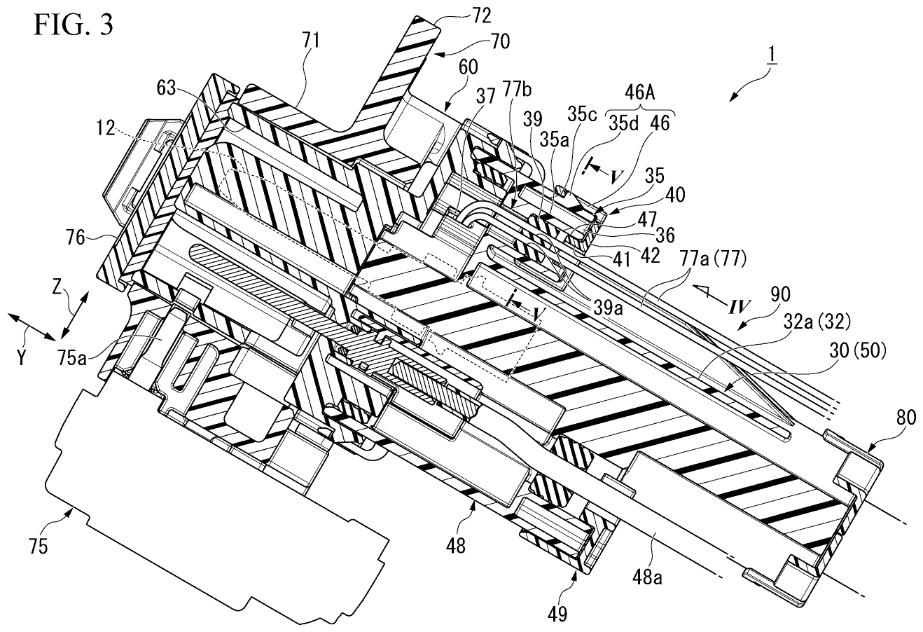

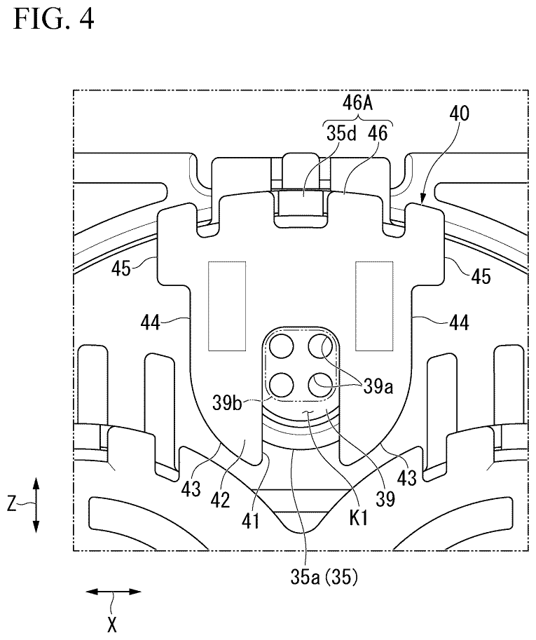

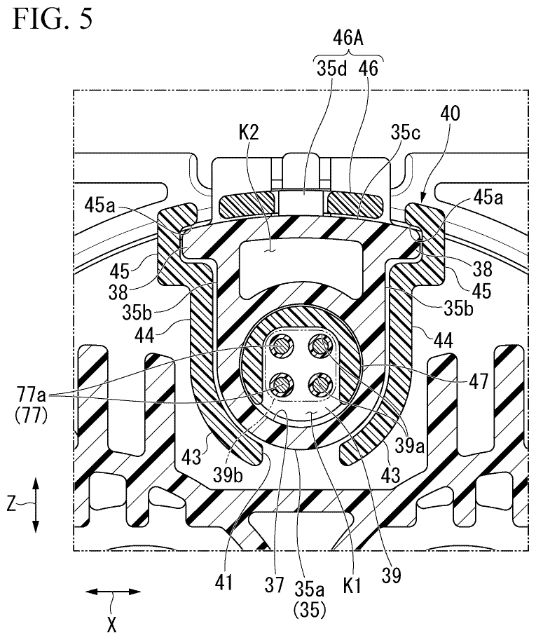

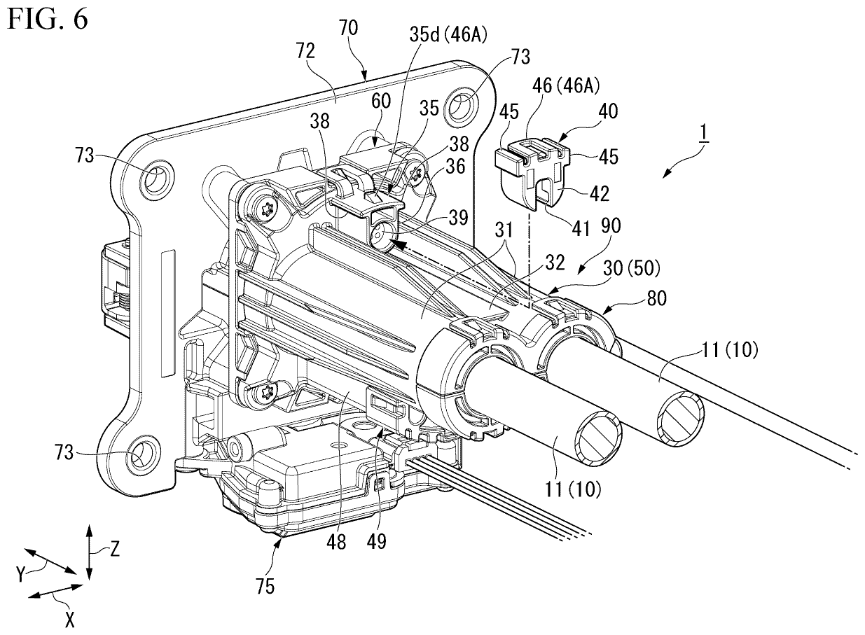

FIGS. 1 and 2 are perspective views of a charging inlet 1 according to one embodiment of the present invention. FIG. 3 is a cross-sectional view along an axial direction of a central portion in a left-right direction of the charging inlet 1. FIG. 4 is a cross-sectional view taken along line A-A of FIG. 3. FIG. 5 is a cross-sectional view taken along line B-B of FIG. 3. FIG. 6 is a perspective view of a state in which a cap member 40 is removed from an upper wiring guide 35. Note that in the present specification, a description will be given on the assumption that an arrow X indicates the left-right direction, an arrow Y indicates a front-rear direction, and an arrow Z indicates an up-down direction.

The charging inlet 1 illustrated in FIGS. 1 and 2 is a connector installed in a vehicle equipped with a battery of an electric vehicle (EV), a plug-in hybrid electric vehicle (PHEV) or the like, and connected to an electric wire extending from the battery mounted on the vehicle. A mating connector such as a charging plug (not illustrated) is detachably fitted into a fitting recessed portion 63 (see FIG. 1 and the like) of the charging inlet 1. The mating connector is connected to an electric wire extending from a power feeding device outside the vehicle. By connecting this mating connector to the charging inlet 1, the electric power is supplied to the battery from the power feeding device outside the vehicle, and the battery is charged.

In the embodiment, a description will be given with a fitting direction (an insertion/removal direction) of the charging inlet 1 and the mating connector (not illustrated) as the front-rear direction. In the front-rear direction, a mating connector side is referred to as a front side, and a charging inlet 1 side is referred to as a rear side. That is, the mating connector is fitted in and connected to the charging inlet 1 by movement from the front side to the rear side, and is removed by movement in the opposite direction. The fitting direction may be inclined forward and upward with respect to a horizontal direction. The left and right in the left-right direction are left and right when facing forward.

As illustrated in FIGS. 1 and 2, the charging inlet 1 includes a pair of terminal-equipped electric wires 10 and a housing 90 in which terminals 12 of the pair of terminal-equipped electric wires 10 are accommodated and the pair of terminal-equipped electric wires 10 are held.

The pair of terminal-equipped electric wires 10 connects one-end portions of the pair of electric wires 11 to the pair of terminals 12, respectively. The other-end portions of the pair of electric wires 11 are connected to the battery (not illustrated). Each of the electric wires 11 includes a conductor core wire and a sheath made of an insulating resin that covers the conductor core wire (both are not illustrated).

The pair of terminals 12 has a same constitution. Each of the terminals 12 extends linearly along the front-rear direction. The terminals 12 are arranged side by side in the left-right direction at intervals. Each of the terminals 12 is inserted into and held in each of a pair of terminal holding portions 31 described later.

For example, each of the terminals 12 is provided with a cylindrical female terminal portion (not illustrated) protruding forward from a front end surface thereof. Among the pair of terminals 12, the female terminal portion of one terminal 12 functions as an anode-side terminal, and the female terminal portion of the other terminal 12 functions as a cathode-side terminal. When the charging inlet 1 and the mating connector are fitted to each other, a male terminal portion on an anode side and a male terminal portion on a cathode side (both not illustrated) of the mating connector are connected to the female terminal portion of the one terminal 12 and the female terminal portion of the other terminal 12, respectively.

Rear end portions of the pair of terminals 12 are connected to the one-end portions of the electric wires 11. The conductor core wire exposed at the one-end portion of the electric wire 11 is connected to the rear end portion of each of the terminals 12 directly or via a prescribed conductor component. With this constitution, the terminals 12 and the one-end portions of the electric wires 11 are electrically connected.

### Housing 90

As illustrated in FIGS. 1 and 2, the housing 90 includes a base holder 50, a rear holder 80, an inner housing body 60, and an outer housing body 70. Each of the base holder 50, the rear holder 80, the inner housing body 60, and the outer housing body 70 is a skeletal component of the housing 90 and forms an outer surface of the housing 90.

The base holder 50 functions to hold the pair of terminal-equipped electric wires 10 in a state of insulating the terminal-equipped electric wires 10 from each other with a space in a width direction. The base holder 50 has a resin holder 30 that is a resin molded article.

The resin holder 30 absorbs and radiates heat generated in the pair of terminals 12, and also functions to insulate and protect the pair of terminals 12. The resin holder 30 integrally includes the pair of terminal holding portions (holder bodies) 31 arranged in the width direction (left-right direction) and a coupling portion 32 coupling the pair of terminal holding portions 31 in the width direction. Each of the terminal holding portions 31 has a substantially cylindrical shape extending in the front-rear direction. The terminal 12 is inserted into each of the pair of terminal holding portions 31 from the rear side.

The coupling portion 32 couples the pair of terminal holding portions 31. An upper wiring guide 35 protruding upward is provided on an upper outer surface (upper surface) 32a of the coupling portion 32. The upper surface 32a of the coupling portion 32 in the embodiment is a plane substantially parallel to a front-rear direction Y and a left-right direction X. The upper wiring guide 35 has a function of guiding routing of electric wires of an electric wire component (for example, a thermistor 77 for terminal temperature detection) different from the electric wire 10 for charging. The cap member 40 is attached to the upper wiring guide 35.

A lower wiring guide 48 protruding downward is provided on a lower outer surface (lower surface) of the coupling portion 32. The lower wiring guide 48 has a function of guiding routing of electric wires of electric wire components (for example, a ground wiring 48a (see FIG. 3), various signal wirings, and the like) different from the electric wire 10 for charging. A cap member 49 is attached to the lower wiring guide 48.

The rear holder 80 is attached to a rear end portion of the base holder 50. The rear holder 80 is a resin molded article, is assembled with the base holder 50 from the rear side, and functions to hold the pair of terminal-equipped electric wires 10 in a state with a space in the width direction.

In front of the base holder 50, the inner housing body 60 having a size that surrounds an outside of the pair of terminal holding portions 31 when viewed from the front-rear direction is provided. The inner housing body 60 has a disk shape with a thickness direction oriented in the front-rear direction, and a front end portion of the base holder 50 is coupled to a rear surface portion of the inner housing body 60. The inner housing body 60 is, for example, a resin molded article integrally formed of a same material as that of the base holder 50. Fastening portions for fastening and fixing the inner housing body 60 to the outer housing body 70 by bolts along the front-rear direction are provided on both left and right sides of an upper portion and both left and right sides of a lower portion of the inner housing body 60.

The outer housing body 70 is assembled with the inner housing body 60 from the front side, and functions to fix the entire housing 90 to an attachment target portion (not illustrated) provided in the vehicle. The outer housing body 70 is a resin molded article, and has a tubular portion 71 having a cylindrical shape and extending in the front-rear direction. The tubular portion 71 functions to form the fitting recessed portion 63 of the charging inlet 1.

In a rear wall portion (bottom wall portion) of the fitting recessed portion 63, a pair of cylindrical female terminal accommodating portions (not illustrated) is provided so as to protrude forward corresponding to the female terminal portions of the pair of terminals 12 (not illustrated). Each of the female terminal accommodating portions is located inside the fitting recessed portion 63, and accommodates each of the female terminal portions therein.

The outer housing body 70 has a flange portion 72 expanding radially outward of the tubular portion 71. The flange portion 72 has a rectangular shape when viewed from the front-rear direction. A bolt insertion hole 73 penetrating in the front-rear direction is formed at each corner portion of the flange portion 72. A bolt (not illustrated) for fixing the charging inlet 1 to the attachment target portion of the vehicle is inserted into the bolt insertion hole 73.

The charging inlet 1 includes an actuator 75 for preventing detachment of the mating connector in a connected state. The actuator 75 is assembled below the charging inlet 1. The actuator 75 includes a lock pin 75a that can be inserted into a prescribed portion of the mating connector in the connected state in a direction (for example, an up-down direction) orthogonal to the fitting direction. The actuator 75 is actuated by a drive signal from a control device (not illustrated), and causes the lock pin 75a to protrude into or retract from the mating connector. With this constitution, it is possible to prevent the mating connector from being accidentally detached or intentionally detached during battery charging, improve safety, and reliably execute a charging cycle every time. The actuator 75 is an independent unit, and is fixed to the housing 90 with bolts and nuts or the like.

A lid 76 for opening and closing a front opening portion of the tubular portion 71 is attached to a front surface side of the outer housing body 70. The lid 76 is rotatable about a hinge shaft 76a disposed on one side of left and right sides (left side in the figure) of the tubular portion 71 and extending in the up-down direction. On the other side of the left and right sides (right side in the figure) of the tubular portion 71, a lock member 76b that holds the lid 76 in a closed state is disposed.

### Thermistor 77, Upper Wiring Guide 35

Referring to FIGS. 3 to 6, the thermistor 77 for detecting a temperature of each of the terminals 12 is disposed on a side of the upper surface 32a of the coupling portion 32 of the housing 90. The thermistor 77 includes wirings 77a extending in the front-rear direction along the upper surface 32a of the coupling portion 32, and a detection element (not illustrated) provided at tip portions (front end portions) of the wirings 77a.

The upper wiring guide 35 that covers a periphery of an attachment portion 77b of the thermistor 77 to the housing 90 and guides routing paths of the wirings 77a is provided above a front portion of the coupling portion 32. The upper wiring guide 35 has a cylindrical guide body 35a, and a space having a circular cross section inside the guide body 35a serves as a routing passage K1 for routing a range of a specified length from the detection element in the wirings 77a of the thermistor 77. A front end portion of the upper wiring guide 35 abuts on and is joined to a rear portion of the inner housing body 60. A front portion of the routing passage K1 reaches an inside of the inner housing body 60, and a front end portion of the routing passage K1 is closed inside the inner housing body 60. A rear end portion of the routing passage K1 is opened rearward at a rear end portion of the upper wiring guide 35. Hereinafter, the rear end portion of the upper wiring guide 35 is referred to as a rear opening portion 36.

An insertion hole 37 through which the detection element of the thermistor 77 enters the housing 90 is opened on an inner side (front end side) of the routing passage K1. The thermistor 77 is inserted into the routing passage K1 from a rear side, and the detection element at the front end portion is inserted into the insertion hole 37 of the housing 90 to be attached. A columnar rubber stopper (waterproof plug) 39 is inserted into a front-rear intermediate portion (not limited to a central portion) of the routing passage K1 together with the wirings 77a. The rubber stopper 39 brings an outer peripheral surface into close contact with an inner peripheral surface of the guide body 35a, and prevents water from entering the inner side (side of the insertion hole 37) of the routing passage K1. In the rubber stopper 39, a plurality of (four) insertion holes 39a through which the plurality of (four in the embodiment) wirings 77a are inserted are formed. By setting an inner peripheral surface of each of the insertion holes 39a to be in close contact with an outer peripheral surface of each of the wirings 77a, entry of water through the insertion hole 39a is prevented. The plurality of insertion holes 39a are disposed at a top of a rectangular region 39b on a side of an inner periphery of the rubber stopper 39.

Referring to FIG. 5, the upper wiring guide 35 includes the guide body 35a having a cylindrical cross section, a pair of vertical wall portions 35b extending upward from both left and right sides of an upper portion of the guide body 35a, and a bridged wall portion 35c extending between upper end portions of the pair of vertical wall portions 35b.

The upper wiring guide 35 has a substantially constant cross section and extends in the front-rear direction. Hereinafter, in a cross-sectional view orthogonal to the front-rear direction of the upper wiring guide 35, a shape surrounded by a lower portion of the guide body 35a, the pair of vertical wall portions 35b, and the bridged wall portion 35c is defined as a cross-sectional shape of the upper wiring guide 35. The cross-sectional shape of the upper wiring guide 35 is substantially the same as a shape of the rear opening portion 36 as viewed from the rear side (shape in rear view).

The upper wiring guide 35 is separated from the coupling portion 32 and the pair of terminal holding portions 31 when viewed from the front-rear direction. In the cross-sectional view of the upper wiring guide 35, a portion surrounded by the upper portion of the guide body 35a, the pair of vertical wall portions 35b, and the bridged wall portion 35c is a lightening space K2. The bridged wall portion 35c is curved in an arc shape so as to follow an outer shape of the inner housing body 60 when viewed from the front-rear direction.

On left and right outer sides of the pair of vertical wall portions 35b, protruding portions (guide-side engagement portions) 38 protruding to the left and right outer sides so as to extend the left and right end portions of the bridged wall portion 35c are provided. An upper end portion (the bridged wall portion 35c and the left and right protruding portions 38) of the upper wiring guide 35 is provided so as to be curved in an arc shape as a whole when viewed from the front-rear direction.

The cap member 40 for partially closing the opening and preventing detachment of the rubber stopper 39 inside the routing passage K1 is attached to the rear opening portion 36 of the upper wiring guide 35. The cap member 40 includes a rear wall portion 42 having an inverted U-shaped cut-out 41 that has a shape similar to the shape in rear view of the rear opening portion 36 and opens downward when viewed from the front-rear direction, a pair of left and right arc wall portions 43 extending forward from both left and right sides sandwiching the cut-out 41 at a lower portion of the rear wall portion 42 and curved along outer peripheral surfaces of both lower sides of the guide body 35a, and a pair of left and right flat wall portions 44 extending forward from both sides of an upper portion of the rear wall portion 42 above the left and right arc wall portions 43 and formed along outer side surfaces of the left and right vertical wall portions 35b.

In addition, the cap member 40 includes a pair of left and right cap-side engagement portions 45 extending forward from both left and right sides of an upper end portion of the rear wall portion 42 and forming guide grooves 45a into which the left and right protruding portions 38 are fitted, a cap-side locking piece 46 extending forward from the upper end portion of the rear wall portion 42 between the left and right cap-side engagement portions 45 and constituting a locking structure 46A for preventing the cap member 40 from falling off together with a locking protrusion 35d protruding on an upper surface portion of the bridged wall portion 35c, and a rubber stopper abutting portion (plug abutting portion) 47 protruding forward from a front surface portion of the rear wall portion 42 in a shape avoiding the cut-out 41, being inserted into the routing passage K1 from the rear opening portion 36 of the guide body 35a, and capable of abutting on a rear end surface of the rubber stopper 39.

When the cap member 40 attached to the upper wiring guide 35 is viewed from the rear side, the cut-out 41 is formed so as to avoid the rectangular region 39b where the plurality of insertion holes 39a of the rubber stopper 39 are disposed. At this time, a portion of the rear wall portion 42 along an upper inner periphery of the cut-out 41 (hereinafter, referred to as a rear wall inner peripheral portion) overlaps an upper outer peripheral portion of the rubber stopper 39. The rubber stopper abutting portion 47 having the inversed U shape in rear end view extends forward so as to protrude forward from this rear wall inner peripheral portion. An internal space extending over the cut-out 41 and the rubber stopper abutting portion 47 extends in the up-down direction with a constant left-right width, and the plurality of wirings 77a can be easily inserted and removed in the up-down direction.

The cap member 40 has an effect of suppressing bending of the wirings 77a in the vicinity of the rubber stopper 39 so that the sealability of the rubber stopper 39 is not affected when a tension in the bending direction is applied due to the routing of the wirings 77a or the like.

Since the cut-out 41 through which the wirings 77a pass has the inverted U-shape, downward bending of the wirings 77a cannot be suppressed in the cap member 40. However, the coupling portion 32 of the housing 90 is located close to below the wirings 77a, and the downward bending of the wirings 77a is suppressed by the housing 90.

Therefore, the influence on the sealability of the rubber stopper 39 can be suppressed in all directions of the wirings 77a.

### Assembling Procedure of Cap Member 40

Next, an assembling procedure of the cap member 40 will be described.

The cap member 40 can be attached to the upper wiring guide 35 in a state where the thermistor 77 is assembled with the housing 90 in advance. That is, when the cap member 40 is attached to the upper wiring guide 35, even in a state where the wirings 77a are already routed, the wirings 77a can be brought from the open portion of the cut-out 41 of the cap member 40 to a cap central portion (a portion located in an extending direction of a wiring insertion portion). With this constitution, as compared with a case where the wiring insertion portion of the cap member 40 has a hole shape, it is not necessary to take a measure such as causing the wirings 77a to pass through the wiring insertion portion of the cap member 40 in advance, so that the assembly of the cap member 40 can be facilitated.

The left and right protruding portions 38 of the upper wiring guide 35 serve as guides for suppressing displacement of the attachment position, inclination in the left-right direction, rotation around the guide body 35a in the cap member 40, and the like. In particular, since the cut-out 41 is opened downward, there is a possibility that the cap member 40 floats upward even when the wirings 77a are inserted. However, the floating of the cap member 40 can be stably suppressed by having the left and right protruding portions 38 and the left and right cap-side engagement portions 45. Even in the constitution in which the cut-out 41 is opened downward, the coupling portion 32 and the pair of terminal holding portions 31 are located close to below the cap member 40, and the water from below is suppressed by the coupling portion 32 and the pair of terminal holding portions 31.

In addition, since the locking structure 46A for fixing the cap member 40 in the attached state is provided at a portion sandwiched between the left and right protruding portions 38 and the left and right cap-side engagement portions 45, the influence on an engagement state of the locking structure 46A due to the movement of the cap member 40 can be suppressed. Therefore, the cap member 40 can be stably fixed even with the single locking structure 46A. Since the coupling portion 32 and the pair of terminal holding portions 31 are located close to below the cap member 40 and the upper wiring guide 35, it is preferable not to provide the locking structure 46A below the cap member 40 and the upper wiring guide 35 in terms of facilitating molding of the housing 90.

### Operation and Effects

The charging inlet 1 of the present embodiment includes: the housing 90 from which a charging plug is detachable, the housing 90 holding connection terminals 12 therein; the wiring component (the thermistor 77) inserted into the housing 90 from an outside of the housing 90 through the upper wiring guide 35 formed on a side of the outer surface (the upper surface 32a) of the outer wall portion (the coupling portion 32) of the housing 90; the waterproof plug (the rubber stopper 39) inserted into the routing passage K1 inside the upper wiring guide 35 together with wirings 77a of the thermistor 77 to close the routing passage K1; and the cap member 40 that is attached to the external opening portion 36 of the upper wiring guide 35, the external opening portion 36 being opened to the outside of the housing 90, and that has the plug abutting portion (the rubber stopper abutting portion) 47 capable of abutting on the waterproof plug inside the upper wiring guide 35 from a side of the external opening portion 36, wherein the cap member 40 includes the U-shaped cut-out 41 opened to a side of the outer wall portion in the second direction (the up-down direction Z) intersecting the outer surface (the upper surface 32a) of the outer wall portion when viewed from the first direction (the front-rear direction Y) along the outer surface of the outer wall portion, and the wirings 77a are inserted into the cut-out 41.

According to this constitution, in the charging inlet 1 in which the wirings 77a of the thermistor 77 or the like are disposed from the upper wiring guide 35 into the housing 90, the routing passage K1 inside the upper wiring guide 35 is watertightly closed by the waterproof plug through which the wirings 77a are inserted, and the sealability inside the housing 90 is secured. The external opening portion 36 of the upper wiring guide 35 is closed by the cap member 40, and the rubber stopper abutting portion 47 of the cap member 40 presses the waterproof plug inside the upper wiring guide 35 to suppress the waterproof plug from falling off. Even if bending (deflection) of the wirings 77a occurs, a force due to the bending is received by the cut-out 41 in front of the waterproof plug, so that the force due to the bending of the wirings 77a is hardly applied to the waterproof plug, and a waterproof property is satisfactorily secured. Since the insertion portion of the wirings 77a in the cap member 40 is the U-shaped cut-out 41 opened to the side of the outer wall portion, the cap member 40 is attached to the upper wiring guide 35 while inserting the wirings 77a into the cut-out 41 in the state where the wirings 77a are assembled with the upper wiring guide 35. With this constitution, it is possible to assemble the charging inlet 1 without passing the wirings 77a in advance, and it is possible to improve assembling workability of the charging inlet 1 without working of sandwiching the wirings 77a in the cap member 40.

In the charging inlet 1 of the embodiment, the upper wiring guide 35 has the peripheral wall portions (the vertical wall portions 35b) extending along the first direction, the external opening portion 36 has the protruding portions 38 that protrude to outsides of the peripheral wall portions in the third direction (the left-right direction X) intersecting the second direction when viewed from the first direction, and the cap member 40 has the cap-side engagement portions 45 that engage with the protruding portions 38.

According to this constitution, the upper wiring guide 35 has the protruding portions 38 each having a projecting shape in the third direction intersecting the second direction (the direction extending over an U-shaped open portion (a lower end portion) and a bottom portion (an upper end portion) of the cut-out 41), and the cap-side engagement portions 45 are engaged with the protruding portions 38, by which the movement of the cap member 40 in the second direction is restricted. Therefore, it is possible to prevent the cap member 40 from floating on a side opposite to the open portion of the cut-out 41, and to suppress rotation of the cap member 40 around peripheries of the wirings 77a, so that stable attachment of the cap member 40 can be realized. Since the protruding portions 38 each have a projecting shape and the protruding portions 38 protrude in the third direction intersecting the second direction, the upper wiring guide 35 is prevented from having a protruding shape (peak shape) outward in the second direction (outward in the housing 90), and the molding of the housing 90 can be facilitated.

In the embodiment, the protruding portions 38 are provided on both the left and right sides of the end portion (the upper end portion) of the external opening portion 36 on the opposite side of the open portion of the cut-out 41, but the protruding portions may be provided at any height in the up-down direction (the second direction) instead of the upper end portion. Further, the number of the protruding portions is not limited to one pair on the left and right, and the protruding portion may be provided singly or three or more.

In the charging inlet 1 of the embodiment, the upper wiring guide 35 includes the locking structure 46A (the locking protrusion 35d) in the end portion opposite to the outer wall portion of the housing 90 in the second direction, the locking structure 46A locking the cap member 40 to restrict detachment in the first direction.

According to this constitution, by providing the locking structure 46A for locking the cap member 40 at the end portion of the upper wiring guide 35 on the side opposite to the outer wall portion of the housing 90 (outside the housing 90) in the second direction, the locking structure 46 A can be easily molded and the housing 90 can be easily manufactured as compared with a case where the locking structure 46A is provided at a portion close to the housing 90.

In the charging inlet 1 of the embodiment, the external opening portion 36 has the protruding portions 38 in the end portion opposite to the outer wall portion of the housing 90 in the second direction, and the upper wiring guide 35 includes the locking structure 46A (the locking protrusion 35d) that locks the cap member 40 and restricts detachment in the first direction in the end portion opposite to the outer wall portion of the housing 90 in the second direction.

According to this constitution, since the protruding portions 38 that restrict the movement in the second direction and rotation of the cap member 40 and the locking structure 46A that restricts the detachment of the cap member 40 in the first direction are collectively disposed at the end portion of the upper wiring guide 35 on the side opposite to the outer wall portion of the housing 90 in the second direction (outside the housing 90), the molding of the protruding portions 38 and the locking structure 46A is easy, and the protruding portions 38 and the locking structure 46A cooperate to restrict the movement of the cap member 40, so that the structure can be simplified, for example, the number of the locking structures 46A can be reduced to one.

In the above embodiment, an example in which the present invention is applied to the upper wiring guide 35 provided above the housing 90 has been described, but the present invention is not limited to this constitution. For example, the present invention may be applied to a wiring guide provided at a lower portion or a side portion of the housing 90.

The protruding portions 38 are provided in the upper wiring guide 35, and the cap-side engagement portions 45 forming the guide grooves 45a are provided in the cap member 40, but the present invention is not limited to this constitution. For example, a recessed engaging portion may be provided in the upper wiring guide 35, and a projecting engagement portion may be provided in the cap member 40.

The constitution in the above embodiment is one example of the present invention, and various modifications can be made without departing from the gist of the present invention, such as replacing the components of the embodiment with known components.

### DESCRIPTION OF REFERENCE SYMBOLS

1 charging inlet
12 connection terminal
32 coupling portion
32a upper surface
35 upper wiring guide (wiring guide)
35b vertical wall portion (peripheral wall portion)
35d locking protrusion (locking structure)
36 external opening portion
38 protruding portion (guide-side engagement portion)
39 rubber stopper (waterproof plug)
40 cap member
45 cap-side engagement portion
45a guide groove
46A locking structure
47 rubber stopper abutting portion (plug abutting portion)
77 thermistor (wiring component)
77a wiring
90 housing
K1 routing passage
X left-right direction
Y front-rear direction
Z up-down direction

1. A charging inlet comprising:
a housing from which a charging plug is detachable, the housing holding connection terminals therein;
a wiring component inserted into the housing from an outside of the housing through a wiring guide formed on a side of an outer surface of an outer wall portion of the housing;
a waterproof plug inserted into a routing passage inside the wiring guide together with the wiring component to close the routing passage; and
a cap member that is attached to an external opening portion of the wiring guide, the external opening portion being opened to the outside of the housing, and that has a plug abutting portion capable of abutting on the waterproof plug inside the wiring guide from a side of the external opening portion,
wherein the cap member includes a U-shaped cut-out opened to a side of the outer wall portion in a second direction intersecting the outer surface of the outer wall portion when viewed from a first direction along the outer surface of the outer wall portion, and the wiring component is inserted into the cut-out.

2. The charging inlet according to claim 1, wherein
the wiring guide has a peripheral wall portion extending along the first direction,
the external opening portion has a guide-side engagement portion that protrudes to an outside of the peripheral wall portion or is recessed to an inside of the peripheral wall portion in a third direction intersecting the second direction when viewed from the first direction, and
the cap member has a cap-side engagement portion that engages with the guide-side engagement portion.

3. The charging inlet according to claim 1, wherein
the wiring guide includes a locking structure in an end portion opposite to the outer wall portion of the housing in the second direction, the locking structure locking the cap member to restrict detachment in the first direction.

4. The charging inlet according to claim 2, wherein
the wiring guide includes a locking structure in an end portion opposite to the outer wall portion of the housing in the second direction, the locking structure locking the cap member to restrict detachment in the first direction.

5. The charging inlet according to claim 2, wherein
the external opening portion has the guide-side engagement portion in an end portion opposite to the outer wall portion of the housing in the second direction, and
the wiring guide includes a locking structure in the end portion opposite to the outer wall portion of the housing in the second direction, the locking structure locking the cap member to restrict detachment in the first direction.
